(19) United States
(12) Patent Application Publication
(10) Pub. No.: US 2017/0074120 A1
(43) Pub. Date: Mar. 16, 2017

(54) DEVICE FOR POSITIONING AN INSPECTION TOOL

(71) Applicant: SAFRAN HELICOPTER ENGINES, Bordes (FR)

(72) Inventors: Thomas DROUIN, Sedzere (FR); Oliver Pierre DESCUBES, Nay (FR)

(73) Assignee: SAFRAN HELICOPTER ENGINES, Bordes (FR)

(21) Appl. No.: 15/123,414

(22) PCT Filed: Feb. 26, 2015
(86) PCT No.: PCT/FR2015/050456

§ 371 Date: Sep. 2, 2016

(30) Foreign Application Priority Data
Mar. 3, 2014 (FR) 1451711

(51) Int. Cl. F01D 25/28; F01D 21/00

(52) U.S. Cl. CPC F01D 25/285; F01D 21/003; F05D 2230/64

(57) ABSTRACT

The present disclosure relates to a device (30) for positioning an inspection tool (130) relative to a flange (10) of a casing (1). The device (30) comprises first and second positioning parts (40, 70) that are assembled together. The first part (40) has a fastener portion (45) suitable for being fastened to the flange (10). The second part (70) includes a hole (75) defining a reference axis (X) for positioning the inspection tool (130); and a positioning surface (85) suitable for co-operating with a circumferential surface (12) of the flange (10) so as to position the reference axis (X) so as to intersect an axis of revolution (Z) of the flange (10). The first and second parts (40, 70) include respective setting surfaces (50, 80) suitable for co-operating together while positioning the reference axis (X) perpendicularly to the axis of revolution (Z).

### FIELD OF THE INVENTION

The present disclosure relates to a device for positioning an inspection tool relative to a casing flange, in particular for positioning an endoscope for use in evaluating local deformations on a movable member mounted inside the casing, and in particular for evaluating erosion of blades of a movable member of a turbine engine, such as the impeller of a centrifugal compressor.

### STATE OF THE PRIOR ART

In known manner, the erosion of a movable member mounted inside a casing is evaluated using an inspection tool, and in particular an endoscope.

Such maintenance inspection is particularly welcome when the movable member is incorporated in a turbine engine, the member then being subjected to high levels of mechanical stress as a result of the high speed at which the member typically revolves. This observation is even more relevant when such a turbine engine has a centrifugal compressor, as is typically true of a helicopter engine, the impeller of the compressor being subjected to high levels of stress centrifugally, with the impact thereof on the blades of said impeller needing to be inspected periodically. As an example of a centrifugal compressor, reference may be made by way of example to international patent application WO 2012/160290 A1 filed by the Applicant.

Furthermore, and in known manner, a casing is subdivided axially into a plurality of segments that are assembled together in pairs by flanges incorporated at the ends of said segments. Under such circumstances, in order to position the inspection tool on the casing, a conventional solution consists in removing some of the assembly bolts between two adjacent flanges, and then in repositioning the bolts with a positioning device suitable for being interposed between the bolts and one of the two flanges. Once that assembly operation has been completed, it enables the device to position the inspection tool facing an opening in the casing, which opening is opened in order to perform the inspection.

Thus, in that conventional solution, the performance of the positioning device depends directly on the constraints imposed by the above-mentioned assembly screws, which can be disadvantageous in many respects.

In particular, the step of placing the positioning device on the casing involves steps of removing said bolts and then putting them back into place, which steps can be lengthy and difficult to perform, in particular when the bolts are difficult to access, as often happens with turbine engines, and that can have an impact on the overall time needed to perform the inspection.

In addition, the accuracy with which the inspection tool is positioned relative to the opening of the casing is determined by the bolts, and their assembly clearance is often too great for obtaining accuracy that is satisfactory for inspection purposes.

Consequently, there exists a need to develop a positioning device that provides better performance.

### SUMMARY OF THE INVENTION

A first aspect of the present disclosure relates to a device for positioning an inspection tool relative to a flange of a casing presenting an axis of revolution, a circumferential surface, and two faces perpendicular to the axis of revolution. The device comprises first and second positioning parts that are dissociated from each other; and assembly means for assembling said parts together. The first part comprises a fastener portion suitable for being fastened on one of the two faces of the flange. The second part includes a hole defining a reference axis for positioning the inspection tool; and a positioning surface suitable for co-operating with the circumferential surface of the flange by positioning the reference axis so that it intersects the axis of revolution. The first and second parts have respective setting surfaces suitable for co-operating together by positioning the reference axis perpendicularly to the axis of revolution.

Thus, the first part of the device may be assembled permanently with the flange of the casing, while the second part of the device can be designed to be removable and to be assembled only temporarily with the flange via the first part. Under such circumstances, inspection can easily be performed without disassembling parts of the engine. In particular, there is no need to remove and subsequently replace some of the bolts used for assembling the flange with an adjacent flange of another segment of the casing each time it is desired to perform an inspection. It suffices to assemble the first part once and for all with these flanges, and then to engage and disengage the second part each time it is desired to perform an inspection.

Furthermore, the accuracy with which the reference axis for the inspection tool is positioned can be better decorrelated from the above-mentioned assembly clearances of bolts, with accuracy being ensured by the positioning surface and by the respective setting surfaces, thereby enabling the reference axis to be accurately oriented both perpendicularly and so as to intersect the axis of revolution of the flange. These surfaces may also provide better stiffness for the assembly. The accuracy with which the reference axis is positioned can thus be improved.

In certain embodiments, the assembly means may comprise means for clamping together respective setting surfaces in the direction of the axis of revolution, thereby enabling any clearance between these two surfaces in this direction to be taken up and thereby further improving the accuracy with which the reference axis is positioned.

In certain embodiments, the assembly means may comprise clamping means for clamping together the positioning surface and the circumferential surface in the direction of the reference axis, thus making it possible to take up any clearance between these two surfaces in this direction and thus further improve the accuracy with which the reference axis is positioned.

In certain embodiments, the assembly means may comprise a threaded rod presenting a threaded portion suitable for being screwed in the second part, and an end suitable for co-operating with a mark incorporated with the first part in order to fasten the first and second parts together. Thus, the first and second parts may be assembled together and separated from each other by moving the threaded rod in the second part in order to engage and disengage co-operation between the end of the rod and the mark.

In certain embodiments, the threaded rod may present a rod axis suitable for being positioned obliquely relative to the reference axis and to the axis of revolution. Thus, the traction force exerted by the end of the threaded rod on the mark can simultaneously comprise a first component parallel to the reference axis and another component parallel to the axis of revolution. Under such circumstances, the assembly means may comprise a single threaded rod for assembling together the first and second parts. In certain embodiments, said rod axis may be contained in a plane parallel to the plane formed by the reference axis and by the axis of revolution. In certain embodiments, these two planes may coincide.

In certain embodiments, the mark and the end of the threaded rod may present respective frustoconical shapes suitable for co-operating together to fasten the first and second parts together. Such frustoconical shapes can in particular make it easier to achieve the above-mentioned oblique contact. In particular, advantage can be taken of such shapes to prevent the second part becoming locked relative to the first part other than in a precise position for achieving optimum positioning of the reference axis.

In certain embodiments, the first part may present a guide portion in line with the mark for the purpose of guiding the end of the threaded rod towards the mark, thereby making it easier to initiate co-operation between the end of the rod and the mark while assembling together the first and second parts.

In certain embodiments, the first part may be suitable for being fastened on the flange in at least two distinct assembly configurations, the transition from one assembly configuration to the other taking place by rotating the first part through 180° about the reference axis. Thus, the first part may be fastened equally well on a flange face opposite from the opening of the casing or on a flange face facing the opening, in the direction defined by the axis of revolution. The cost of an inspection requiring mounting in either of these two configurations can thus be reduced by such standardization of the first part.

In certain embodiments, the first part may be plane.

In certain embodiments, the positioning surface may be discontinuous.

A second aspect of the present disclosure provides an assembly comprising a casing flange assembled with a device of the above-specified first aspect.

A third aspect of the present disclosure provides a turbine engine including a movable member mounted to rotate in a casing that is provided with an assembly in accordance with the second above-mentioned aspect.

In certain embodiments, the turbine engine may include a centrifugal compressor, and the movable member may comprise an impeller incorporated in the centrifugal compressor.

The above-mentioned characteristics and advantages, and others, appear more clearly on reading the following detailed description of embodiments having no limiting character and that are proposed merely by way of illustration. The detailed description refers to the accompanying drawings.

### BRIEF DESCRIPTION OF THE DRAWINGS

The accompanying drawings are diagrammatic and not to scale, seeking above all to illustrate the principles set out in the present disclosure. In the accompanying drawings:

FIG. 1 is an exploded view of a positioning device in accordance with the present disclosure;

FIG. 2 is an exploded view of the device viewed from a different angle;

FIG. 3 is a perspective view showing the first and second parts of the device being assembled together;

FIG. 4 is a perspective view showing the positioning of the inspection tool on the second part, once the second part has been assembled with the first part;

FIGS. 5A and 5B are section views on a plane containing the axis of revolution of the flange and the reference axis showing a threaded rod screwed into the second part in two distinct positions relative to a mark incorporated in the first part;

FIG. 5C is an enlargement of a detail VC shown in FIG. 5A;

FIG. 6 is a perspective view of the first part and of the threaded rod in a non-assembled state; and

FIGS. 7 and 8 are plane views of the device, respectively looking along directions VII and VIII shown in FIG. 4.

### DETAILED DESCRIPTION OF EMBODIMENTS

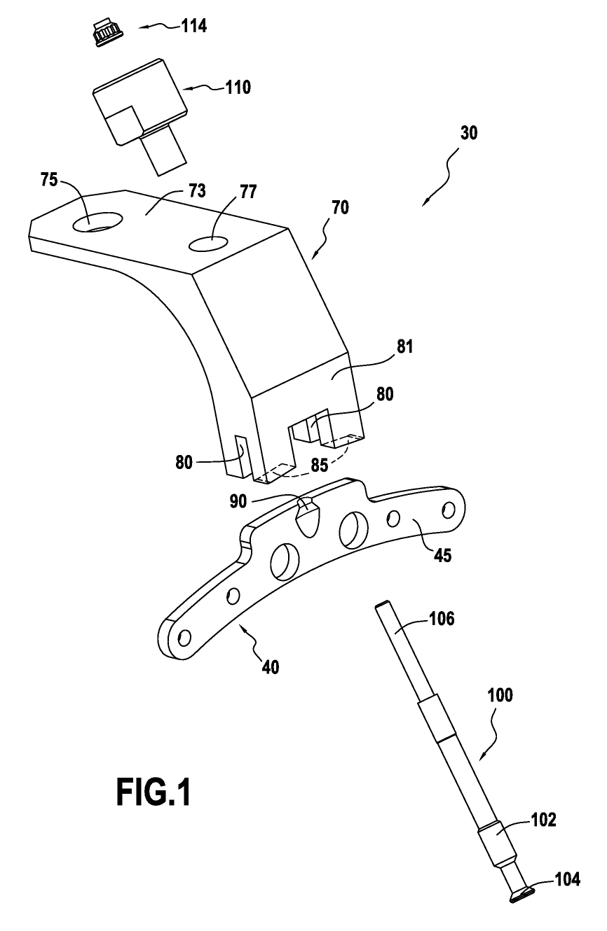

In the embodiment shown (see in particular FIGS. 1 to 4), a device in accordance with this embodiment is a device 30 for positioning an inspection tool 130 relative to a flange 10 of a casing 1 presenting an axis of revolution Z, a circumferential surface 12, and two faces 14 and 16 perpendicular to the axis of revolution Z. The device 30 has first and second positioning parts 40 and 70 that are dissociated from each other; and assembly means 90 and 100 for assembling said parts 40 and 70 together. The first part 40 has a fastener portion 45 suitable for being fastened on one of the two faces 14 and 16 of the flange 10. The second part 70 includes a hole 75 defining a reference axis X for positioning the inspection tool 130; and it also has a positioning surface 85 suitable for co-operating with the circumferential surface 12 of the flange 10, positioning the reference axis X so that it intersects the axis of revolution Z. The first and second parts 40 and 70 have respective setting surfaces 50 and 80 suitable for co-operating together to position the reference axis X perpendicularly to the axis of revolution Z.

In this embodiment, the casing 1 forms an integral portion of a turbine engine having a movable member (not shown) on which it is desired to inspect the state of wear. For example, the turbine engine may be for incorporating in a helicopter as an engine of the helicopter, and it may include a centrifugal compressor. The movable member may then comprise an impeller rotatably mounted in the centrifugal compressor and presenting a leading edge that needs to be inspected regularly for its level of erosion. In this embodiment, the axis of revolution Z of the flange 10 coincides with an axis of revolution of the rotary member.

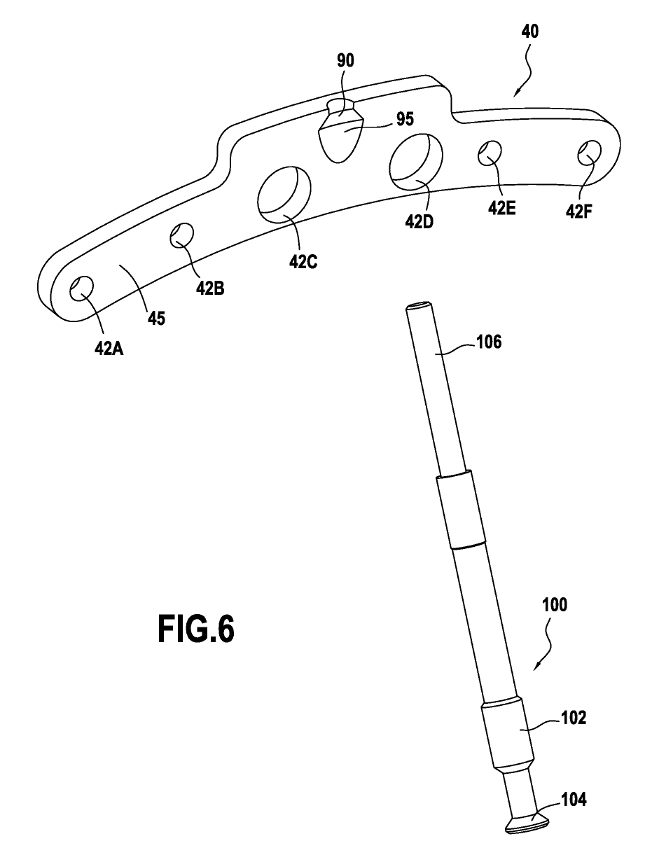

In this embodiment, the first part 40 is designed to be fastened permanently on one of the two faces 14 and 16 of the flange 10 incorporated at one end of a segment of the casing 1. Specifically, the first part 40 is in the form of a plate of thickness measured along the axis Z and presenting two opposite radial surfaces. Thus, in this embodiment, the first part 40 is designed to remain permanently on this segment of the casing 1, even while the engine is in operation. Furthermore, it is possible by way of example for the flange 10 to be arranged at an air inlet of the engine, so that once the device 30 and the inspection tool 130 are installed it is possible to undertake an inspection at the air inlet. In addition, in this embodiment, the first part 40 is designed to be fastened to the flange 10 after the flange has already been assembled with another adjacent flange incorporated in another segment of the casing (not shown). In this embodiment, the fastener portion 45 of the first part 40 is suitable for being fastened against the face 16 of the flange 10 using one or more bolts (in particular two bolts, visible in FIG. 8), suitable for passing through through holes 42A to 42F formed in the fastener portion 45 (see FIG. 6). Some of these through holes (referenced 42C and 42D in FIG. 6) present greater respective dimensions in a direction extending transversely to said holes so as to enable them to receive the heads of bolts or nuts used for assembling together adjacent flanges, without these bolts interfering with fastening the first part 40 on the flange 10. In addition, other through holes (referenced 42A, 42B, 42E, and 42F in FIG. 6) present smaller respective dimensions in a direction transverse to said holes so as to enable the heads of bolts for assembling the first part 40 with the flange 10 to bear against the edges of these holes. Thus, in this embodiment, the first part 40 may be fastened to the flange 10 without disassembling parts of the engine.

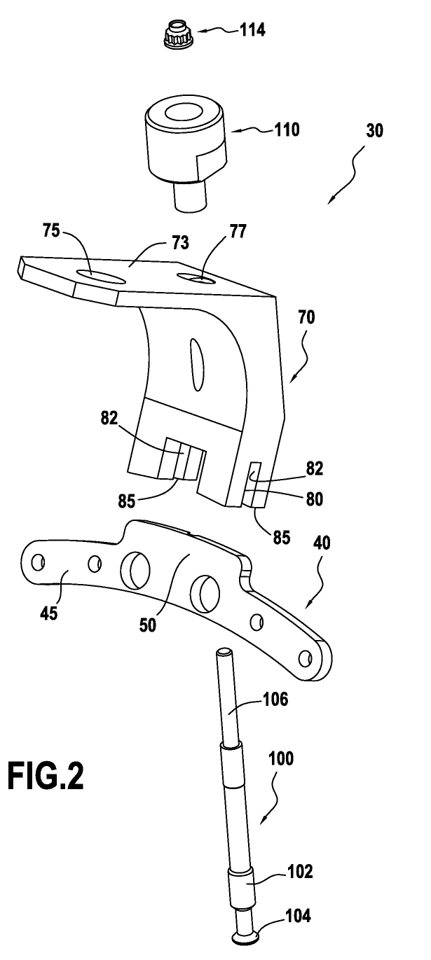

In this embodiment, the fastener portion 45 has a first face suitable for being pressed against the face 16 of the flange 10 so that the first face is positioned parallel to the face 16 when the first part 40 is fastened against this face 16. Furthermore, in this embodiment, the first part 40 presents a second face 50 (see FIG. 2) that is opposite and parallel to the first face and that defines a setting surface for the first part 40.

In this embodiment, the first part 40 is suitable for being fastened to the flange 10 in at least two distinct assembly configurations, with the transition from one assembly configuration to the other taking place by turning the first part 40 through 180° about the reference axis X. In addition, in this embodiment, the first part 40 is plane. It presents a first plane of symmetry that is to be perpendicular to the axis of revolution Z, with the first part 40 fastened to the flange 10. Furthermore, in this embodiment, the first part 40 presents a second plane of symmetry, perpendicular to the setting surface 50. This second plane of symmetry is thus perpendicular to the first plane of symmetry and is to be parallel to the plane formed by the reference axis X and the axis of revolution Z when the first part 40 is fastened to the flange 10 and the second part 70 is assembled with the first part 40.

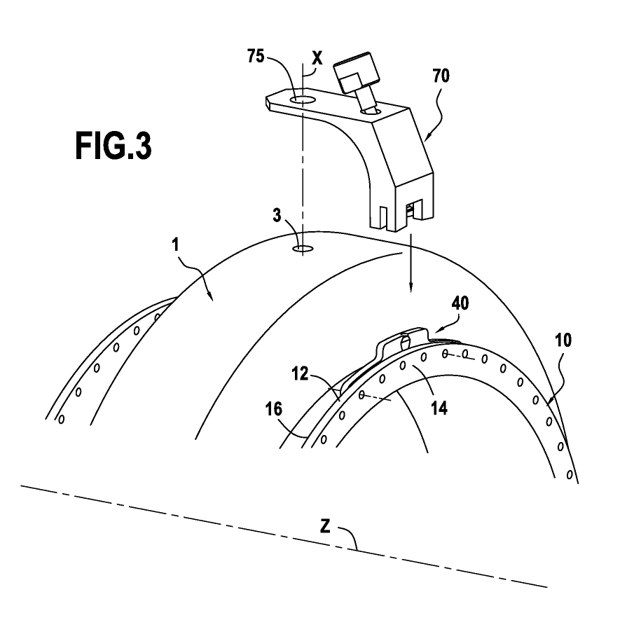

Furthermore, as shown in FIG. 3, the second part 70 is assembled temporarily with the first part 40, and is then removed, each time it is desired to perform an inspection operation.

In this embodiment, the second part 70 is positioned relative to the first part 40 and to the flange 10 by using the positioning surface 85 and the setting surface 80 of the second part 70.

In this embodiment, the positioning surface 85 is such that it is possible to define a cylinder that is tangential to said positioning surface 85 at at least two points of contact with the surface, said tangential cylinder presenting an axis of revolution that intersects the reference axis X. Specifically, the positioning surface 85 is oriented circumferentially relative to the axis Z. In this example, the flange 10 may be modeled geometrically as a cylinder presenting an axis of revolution Z. Under such circumstances, the positioning surface 85 is suitable for resting against the circumferential surface 12 of the flange 10, at least at the two above-mentioned points, by positioning the reference axis X so that it intersects the axis of revolution Z.

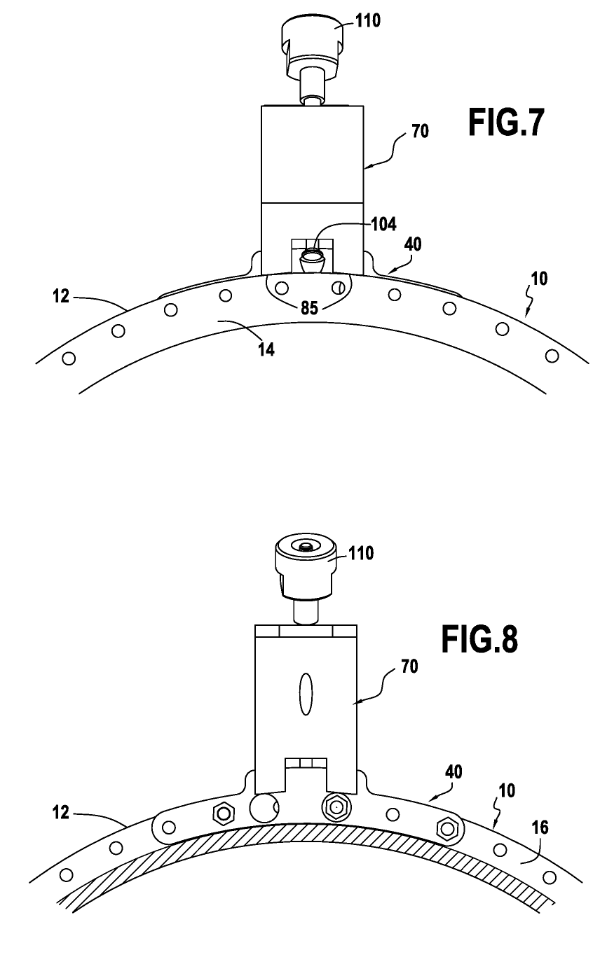

In addition, in this embodiment, the positioning surface 85 is discontinuous (nevertheless, provision could be made for a surface that is continuous without going beyond the scope of the present disclosure). In this embodiment, the positioning surface 85 is constituted by a plurality of faces. More precisely, in this embodiment, the positioning surface 85 is constituted by a pair of faces that are at a distance from each other, and that together form the two branches of a V-shape against which the circumferential surface 12 of the flange 10 is suitable for resting (see FIGS. 1 and 7).

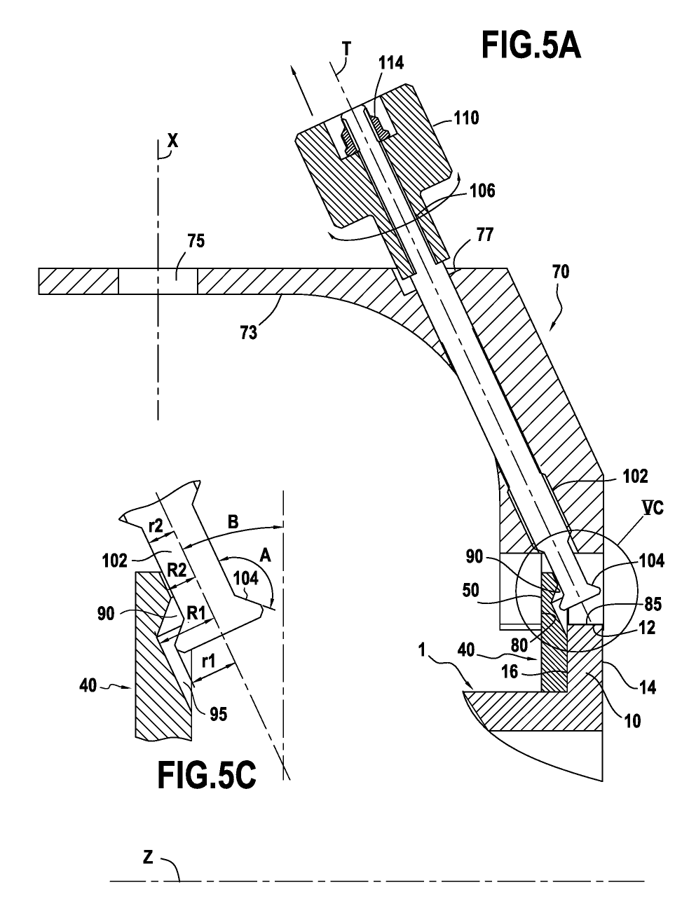

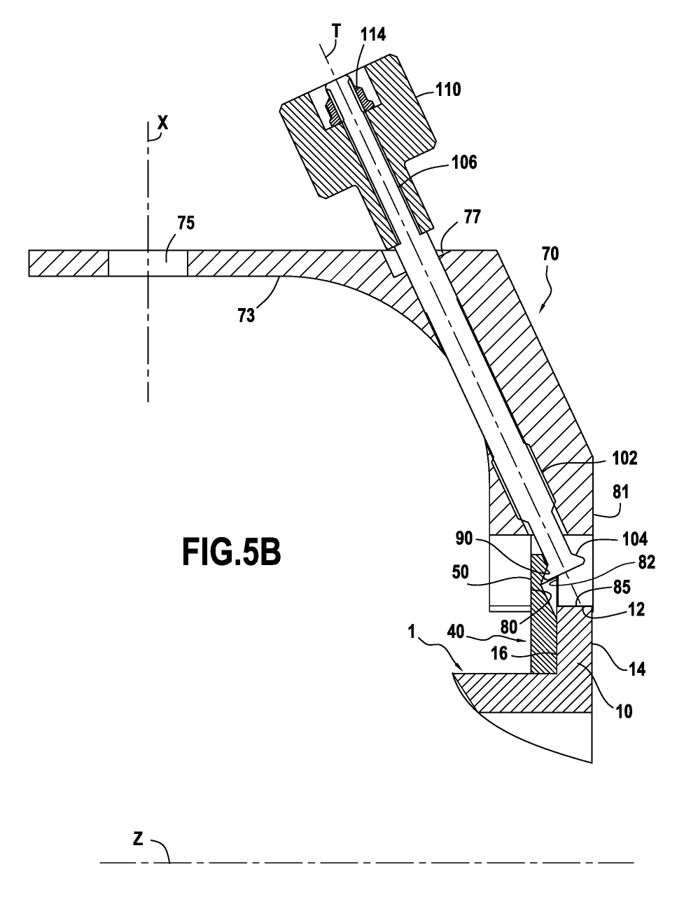

Furthermore, in this embodiment, the setting surface 80 of the second part 70 is designed to be plane so as to be capable of establishing plane-against-plane thrust against the setting surface 50 of the first part 40 when these two parts are assembled together (see FIG. 5A). In this embodiment, the plane of the setting surface 80 is configured to extend perpendicularly to the axis of revolution Z of the flange 10 when the first and second parts 40 and 70 are assembled together and the first part 40 is fastened to the flange 10. In addition, the plane of the setting surface 80 extends parallel to the reference axis X. Under such circumstances, the respective setting surfaces 50 and 80 are suitable for co-operating together while positioning the reference axis X perpendicularly to the axis of revolution Z when the first and second parts 40 and 70 are assembled together and the first part 40 is fastened to the flange 10.

Furthermore, the positioning device 30 has assembly means 90 and 100 for assembling the first and second parts 40 and 70 together. In this embodiment, the assembly means 90 and 100 comprise a threaded rod 100 presenting a threaded portion 102 suitable for being screwed into the second part 70, and an end 104 suitable for co-operating with a mark 90 incorporated in the first part 40 so as to fasten the first and second parts 40 and 70 together (see in particular FIGS. 5A to 5C). In particular, in this embodiment, the second part 70 presents a tapped hole 77 into which the threaded portion 102 of the threaded rod 100 is screwed, the end 104 projecting from a first edge of the hole 77 so as to be capable of co-operating with the mark 90. Thus, in this embodiment, moving the threaded rod 100 in the hole 77 by a screwing/unscrewing operation serves to vary the projecting length of the end 104. In this embodiment, in order to make this operation easier, the threaded rod 100 presents another end 106 opposite from the end 104 that projects from the opposite edge of the hole 77 and that is threaded so as to be suitable for being constrained to turn with a knob 110 that is held on by a nut 114.

Furthermore, in this embodiment, the threaded rod 100 presents a rod axis T that is suitable for being positioned obliquely relative to reference axis X and to the axis of revolution Z. More particularly, in this embodiment, the rod axis T is suitable for being contained in a plane parallel to the reference axis X and to the axis of revolution Z, in particular a plane containing the reference axis X and the axis of revolution Z. Furthermore, in this embodiment, the rod axis T forms an angle B with the reference axis X that lies in the range 10° to 70°, and in particular in the range 15° to 50°.

In this embodiment, the mark 90 is concave in shape. Nevertheless, without going beyond the scope of the present disclosure, it would be possible to provide a shape that is convex, providing only that the end 104 of the threaded rod 100 is suitable for co-operating with the mark 90 in order to fasten the first and second parts 40 and 70 together. Furthermore, in this example, the mark 90 presents an axis of symmetry that coincides with the rod axis T when the first and second parts 40 and 70 are assembled together. Nevertheless, without going beyond the scope of the present disclosure, it would be possible to provide a mark 90 of a shape other than that described above, providing only that the end 104 of the threaded rod 100 is suitable for co-operating with the mark 90 in order to assemble the first and second parts 40 and 70 together.

In addition, in this embodiment, the mark 90 and the end 104 of the threaded rod 100 present respective frustoconical shapes (portions of truncated cones) suitable for co-operating together to fasten the first and second parts 40 and 70 together. In this embodiment, each of these two frustoconical shapes presents an axis of symmetry that coincides with the rod axis T. Furthermore, in this embodiment, each of these two frustoconical shapes presents a half-angle at the apex lying in the range 15° to 70°, and in particular in the range 20° to 60°. Thus, the supplementary angle A of this half-angle, as shown in FIG. 5C, lies in the range 110° to 165°, and in particular in the range 120° to 160°. In addition, in this example, the truncated cone portion defining the mark 90 presents a larger radius R1 and the truncated cone portion defining the end 104 presents a larger radius r1, each of which lies in the range 3 millimeters (mm) to 7 mm, with a difference R1−r1 lying in the range 0.5 mm to 2 mm. Likewise, in this example, the truncated cone portion defining the mark 90 presents a smaller radius R2 and the truncated cone portion defining the end 104 presents a smaller radius r2 each of which lies in the range 1 mm to 5 mm, with a difference R2−r2 lying in the range 0.1 mm to 1.5 mm.

Furthermore, in this embodiment, the first part 40 presents a guide portion 95 in line with the mark 90 for the purpose of guiding the end 104 of the threaded rod 100 towards the mark 90. In this example, this guide portion 95 is concave in shape. Nevertheless, without going beyond the scope of the present disclosure, it would be possible for it to have a shape that is convex, provided only that the end 104 of the threaded rod 100 can be guided by the guide portion to the mark 90. In addition, in this embodiment, the guide portion 95 presents an axis of symmetry that coincides with the rod axis T when the first and second parts 40 and 70 are assembled together. Furthermore, in this embodiment, the guide portion 95 presents a cylindrical shape (it is a portion of a cylinder) of radius equal to the larger radius R2 of the truncated cone portion defining the mark 90. Nevertheless, without going beyond the scope of the present disclosure, the guide portion 95 could have a shape other than that described above, provided only that the end 104 of the threaded rod 100 can be guided by the guide portion to the mark 90. Furthermore, the respective shapes of the mark 90 and/or of the guide portion 95 may advantageously, although not necessarily, be optimized in order to avoid particles of powder accumulating in these shapes, in particular when an inspection is to be made at an engine air inlet, as mentioned above.

Furthermore, in this embodiment (see in particular FIGS. 1, 2, and 5A), the second part 70 presents an overall shape in the form of a bracket having two arms 73 and 81, the hole 75 defining the reference axis X being made in a first one 73 of these two arms, while the setting surface 80 and the positioning surface 85 are defined on the second arm 81. More particularly, in this embodiment, the second arm 81 presents a first notch extending in a plane perpendicular to the axis of revolution Z. This first notch enables two mutually parallel plane internal surfaces 80 and 82 to be defined facing each other and perpendicular to the axis of revolution Z, one of these two internal surfaces defining the setting surface 80. These two internal surfaces make it easier to guide the second part 70 towards its mounted position while assembling the first and second parts 40 and 70 together. Furthermore, in this embodiment, the positioning surface 85 is defined in a distal end of the second arm 81 (relative to the first arm 73). In this embodiment, the second arm 83 presents a second notch that extends in a plane perpendicular to the plane in which the first notch extends so as to leave room for passing the second end 104 of the threaded rod 100. In this embodiment, it is the second notch that is responsible for the discontinuity presented by the positioning surface 85.

There follows a description in greater detail of using the positioning device 30 to carry out an inspection.

As explained above, the first step consists in temporarily assembling the second part 70 with the first part 40 which has itself already been fastened in permanent manner on the flange 10.

To do this, and as shown in FIGS. 3 and 5A, it is necessary to begin by using the knob 110 to screw the threaded rod 100 in sufficiently for the end 104 of the rod to project far enough to be engaged in the guide portion 95 once the second part 70 is correctly positioned relative to the first part 40.

Thereafter, it is necessary to screw the threaded rod 100 out so that the end 104 projects less and less from the hole 77, so that after being guided by the guide portion 95 it becomes inserted into the mark 90 and ends up by being clamped against the mark 90 as a result of the traction force generated by the threaded rod 100 and as a result of the matching shapes of the mark 90 and of the end 104, as can be seen in FIG. 5B. In this configuration, this clamping force has a first component along the direction of the reference axis X, thereby clamping the positioning surface 85 and the circumferential surface 12 against each other along the direction of the reference axis X; and a second component along the direction of the axis of revolution Z, thereby clamping the respective setting surfaces 50 and 80 against each other in the direction of the axis of revolution Z. Thus, in a positioning device 30 as configured in this way, the assembly means 90 and 100 comprise means for clamping together the respective setting surface 50 and 80 in the direction of the axis of revolution Z, and means for clamping together the positioning surface 85 and the circumferential surface 12 in the direction of the reference axis X.

In addition, as shown in FIG. 3, once the first and second parts 40 and 70 have been assembled together, the hole 75 defining the reference axis X is correctly positioned facing an opening 3 in the casing 1, which opening is opened specifically for inspection purposes.

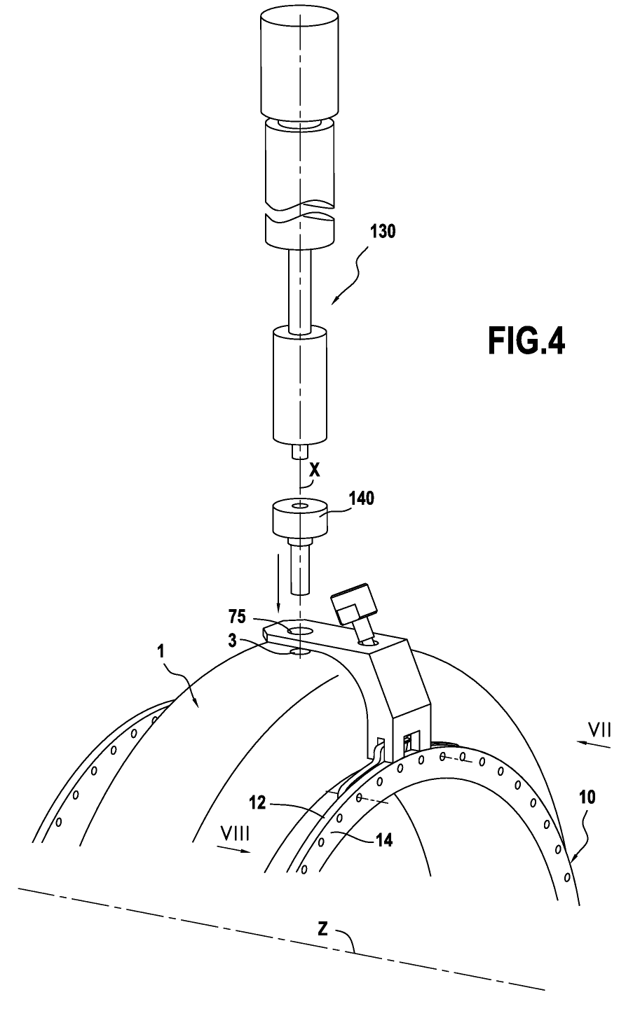

As shown in FIG. 4, the second step consists in positioning the inspection tool 130 by causing the optical sighting axis of the tool to coincide with the reference axis X. In this embodiment, this is done by mounting the inspection tool 130 in a cylindrical sleeve 140 that is itself mounted in the hole 75. Furthermore, in this embodiment, the inspection tool 130 comprises an endoscope presenting an optical axis defining the sighting axis of the inspection tool 130.

Once this second step has been completed, a third step may be performed that corresponds to the inspection step proper. During this stage, by using the positioning device 30, the optical axis is appropriately positioned perpendicularly so as to intersect the axis of revolution of the flange 10, which is also the axis of revolution of the movable member for inspection.

Finally, once this third step has been completed, in order to terminate the inspection, it suffices to remove the inspection tool 130 and then the second part 70 in a manner opposite to that described above respectively for the second and first steps.

The embodiments described in the present description are given by way of non-limiting illustration, and in the light of this description, a person skilled in the art can easily modify these embodiments or envisage others, while remaining within the scope of the invention.

Furthermore, the various characteristics of these embodiments can be used singly or in combination with one another. When they are combined, these characteristics may be combined as described above or in other ways, the invention not being limited to the specific combinations described in the present description. In particular, unless specified to the contrary, any characteristic described with reference to any embodiment may be applied in analogous manner to any other embodiment.

1. A device for positioning an inspection tool relative to a flange of a casing presenting an axis of revolution, a circumferential surface, and two faces perpendicular to the axis of revolution, the device being characterized in that wherein:
the device comprises first and second positioning parts that are dissociated from each other; and assembly means for assembling said parts together;
the first part comprises a fastener portion suitable for being fastened on one of the two faces of the flange;
the second part includes a hole defining a reference axis for positioning the inspection tool; and a positioning surface suitable for co-operating with the circumferential surface of the flange by positioning the reference axis so that it intersects the axis of revolution; and
the first and second parts have respective setting surfaces suitable for co-operating together by positioning the reference axis perpendicularly to the axis of revolution.

2. A device according to claim 1, wherein the assembly means comprise means for clamping together respective setting surfaces in the direction of the axis of revolution.

3. A device according to claim 1, wherein the assembly means comprise clamping means for clamping together the positioning surface and the circumferential surface in the direction of the reference axis.

4. A device according to claim 1, wherein the assembly means comprise a threaded rod presenting a threaded portion suitable for being screwed in the second part, and an end suitable for co-operating with a mark incorporated with the first part in order to fasten the first and second parts together.

5. A device according to claim 4, wherein the threaded rod presents a rod axis suitable for being positioned obliquely relative to the reference axis and to the axis of revolution.

6. A device according to claim 4, wherein the mark and the end of the threaded rod present respective frustoconical shapes suitable for co-operating together to fasten the first and second parts together.

7. A device according to claim 4, wherein the first part presents a guide portion in line with the mark for the purpose of guiding the end of the threaded rod towards the mark.

8. A device according to claim 1, wherein the first part is suitable for being fastened on the flange in at least two distinct assembly configurations, the transition from one assembly configuration to the other taking place by rotating the first part through 180° about the reference axis.

9. A device according to claim 1, wherein the first part is plane.

10. A device according to claim 1, wherein the positioning surface is discontinuous.
